(19) United States
(12) Patent Application Publication
(10) Pub. No.: US 2017/0346236 A1
(43) Pub. Date: Nov. 30, 2017

(54) ELECTRICAL CONNECTOR ASSEMBLY

(71) Applicant: LOTES CO., LTD, Keelung (TW)

(72) Inventor: Quan Long, Keelung (TW)

(21) Appl. No.: 15/679,515

(22) Filed: Aug. 17, 2017

Related U.S. Application Data
(63) Continuation of application No. 15/077,160, filed on Mar. 22, 2016.

(30) Foreign Application Priority Data
May 25, 2015 (CN) 201520340608.9

(51) Int. Cl. H01R 13/659; H01R 24/60

(52) U.S. Cl. CPC H01R 13/659; H01R 24/60

(57) ABSTRACT

An electrical connector assembly includes a first body, multiple first terminals disposed in the first body, a metal inner shell wrapping a periphery of the first body to form an insertion space between the metal inner shell and the first body, and a first metal casing disposed outside of the metal inner shell. The metal inner shell has a front end that exceeds beyond the first metal casing. The first metal casing has a top wall, which has a front edge bending and extending upward to form a first extending plate. The front edge of the top wall is provided with a first concave portion located at a side of the first extending plate, and is further continuously provided with a protruding portion and a second concave portion from the first concave portion along a direction away from the first extending plate.

### CROSS-REFERENCE TO RELATED APPLICATION

This application is a continuation application of U.S. application Ser. No. 15/077,160, filed Mar. 22, 2016, which itself claims priority to and benefit of, under 35 U.S.C. §119(a), Patent Application No. 201520340608.9 filed in P.R. China on May 25, 2015. The entire contents of the above-identified applications are incorporated herein by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to an electrical connector assembly, and more particularly to an electrical connector assembly having a metal member.

### BACKGROUND OF THE INVENTION

The background description provided herein is for the purpose of generally presenting the context of the present invention and is neither expressly nor implied admitted as prior art against the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

In paragraph [0033] of the specification of Chinese Patent Application Publication No. CN201010506577.1, a shielding cover, a shielding casing and a substrate module are disclosed, where a pair of contact portions in a plate shape extends from end portions at lower ends of two side wall portions. Each of the contact portions is folded back from a top plate portion. An end portion of the contact portion is bent toward the inner side into a rough V shape. A distance between the tops of the end portions is less than a distance between outer side surfaces of a casing body of a metal casing. Therefore, when the casing body of the metal casing is inserted between the end portions of the contact portions, the tops of the end portions of the contact portions elastically contact two outer side surfaces of the casing body of the metal casing and are sandwiched between the two outer side surfaces. Therefore, grounding communication is achieved between the contact portions and the metal casing.

This contact portion structure disclosed in the above patent application is easily deformed toward a corresponding side wall portion, which affects grounding performance of the contact portion; and after the contact portions are subject to a force, elastic fatigue is easily generated or the contact portions are broken because the force is excessively violent, thereby causing poor contact between the contact portions and the two outer side surfaces of the casing body of the metal casing, so that product quality is deteriorated and the grounding performance is not good.

Therefore, a heretofore unaddressed need exists in the art to address the aforementioned deficiencies and inadequacies.

### SUMMARY OF THE INVENTION

In one aspect, the present invention relates to an electrical connector assembly that is not easily deformed, provides stable contact, and has high quality and good grounding performance.

In one embodiment, an electrical connector assembly includes an insulating body having an accommodating cavity, a metal member retained to the outside of the insulating body, and a first connector disposed in the accommodating cavity. The accommodating cavity has two opposite side walls. The metal member has two side plates and two urging portions respectively connected to the two side plates. The urging portions are disposed in the accommodating cavity, and each of the side walls is disposed between the corresponding urging portion and the corresponding side plate. The first connector has a first metal casing. The urging portions urge the first metal casing, and each of the urging portion is located between the corresponding first metal casing and the corresponding side wall.

In one embodiment, each of the side walls is provided with a notch, and each of the urging portions bypasses the corresponding notch and is bent, and extends into the accommodating cavity.

In one embodiment, the metal member is provided with a front plate and two side plates connected to two sides of the front plate, and each of the urging portions extends from the corresponding side plate and bypasses the corresponding side wall to enter the accommodating cavity.

In one embodiment, each of the urging portions extends downward from the corresponding side plate and is reversely bent into the accommodating cavity.

In one embodiment, a grounding pin extends downward from each of the side plates, and a gap exists between the corresponding grounding pin and the corresponding urging portion.

In one embodiment, a first buckling portion and a second buckling portion are disposed on each of the side plates, and the insulating body is provided with a first snap-fit slot and a second snap-fit slot that correspond to each of the first buckling portions and each of the second buckling portions.

In one embodiment, each of the first buckling portions is connected to the corresponding grounding pin, and each of the first buckling portions and the corresponding urging portion are located at a same height.

In one embodiment, each side surfaces of the insulating body is provided with a groove, and each of the side plates is located in the corresponding groove.

In another aspect, the present invention relates to an electrical connector assembly. In one embodiment, an electrical connector includes an insulating body and a metal member disposed at the outer side of the insulating body. The insulating body at least has a first accommodating cavity and a second accommodating cavity. The first accommodating cavity and the second accommodating cavity accommodate a first metal casing and a second metal casing, respectively. The metal member is connected to the first metal casing and the second metal casing. The metal member has a front plate and side plates connected to two sides of the front plate. An urging portion extends downward from each of the side plates and is bent and extends from the outer side of the insulating body into the first accommodating cavity. Each of the urging portions urges a side of the first metal casing, and each of the urging portions is located between the first metal casing and the insulating body.

In one embodiment, the first accommodating cavity has two opposite side walls, each of the side walls is provided with a notch, and each of the urging portions extends downward from the corresponding side plate, bypasses the corresponding notch and is reversely bent into the first accommodating cavity.

In one embodiment, the first accommodating cavity has two opposite side walls, each of the urging portions extends downward from the corresponding side plate, passes through the corresponding side wall and is reversely bent into the first accommodating cavity.

In one embodiment, a contact portion extends from an upper side edge of the front plate into the second accommodating cavity, and the contact portion is in contact with the second metal casing.

In one embodiment, a grounding pin extends downward from each of the side plates, and a gap exists between each of the grounding pins and the corresponding urging portion.

In one embodiment, a first buckling portion and a second buckling portion are disposed on each of the side plates, and the insulating body is provided with a first locking slot and a second locking slot that correspond to the first buckling portion and the second buckling portion.

In one embodiment, the first buckling portion is connected to the corresponding grounding pin, and the first buckling portion and the corresponding urging portion are located at a same height.

In one embodiment, the front plate is located between the first metal casing and the second metal casing, and both the first metal casing and the second metal casing protrude forward from the front plate.

In one embodiment, each of side surfaces of two opposite sides of the insulating body is provided with a groove, and the side plates are respectively located in the grooves.

In another aspect, the present invention relates to an electrical connector assembly, which includes: a first body; a plurality of first terminals disposed in the first body; a metal inner shell wrapping a periphery of the first body to form an insertion space between the metal inner shell and the first body; and a first metal casing disposed outside of the metal inner shell, wherein the metal inner shell has a front end exceeding beyond the first metal casing, the first metal casing comprises a top wall, the top wall has a front edge bending and extending upward to form a first extending plate, and wherein the front edge of the top wall is provided with a first concave portion located at a side of the first extending plate, and is further continuously provided with a protruding portion and a second concave portion from the first concave portion along a direction away from the first extending plate.

In one embodiment, the first extending plate has a first connection portion extending from the front edge of the top wall, and a first extending portion bending upward from the first connection portion, wherein the first connection portion exceeds beyond a front edge of the protruding portion.

In one embodiment, the first extending portion and the top wall are provided to be perpendicular to each other.

In one embodiment, the first extending portion and a front edge of the metal inner shell are flush in a vertical direction.

In one embodiment, the first connection portion extends horizontally forward from the front edge of the top wall.

In one embodiment, the first metal casing has two side extending walls respectively connected to two sides of the top wall, the two side extending walls are respectively located at two outer sides of the metal inner shell, and two second extending plates are respectively formed by bending and extending from front edges of the two side extending walls along directions away from the metal inner shell.

In one embodiment, each of the second extending plates has a second connection portion extending from the front edge of the corresponding side extending wall, and a second extending portion bending sideward from the second connection portion, wherein the second connection portion exceeds beyond the front edge of the protruding portion.

In one embodiment, a length of the first extending portion is greater than a length of the second extending portion.

In one embodiment, a width of the first extending portion is greater than a width of the second extending portion.

In one embodiment, the second extending portion and the top wall are provided to be perpendicular to each other, and the first extending portion and the second extending portion are flush in a vertical direction.

In one embodiment, a width of the first concave portion is greater than a width of the second concave portion.

In one embodiment, a depth of the first concave portion in a front-rear direction is greater than a depth of the second concave portion in the front-rear direction.

In one embodiment, the front edge of the top wall is provided with two first concave portions, two protruding portions and two second concave portions respectively located at two sides of the first extending plate.

In one embodiment, the two first concave portions, the two convex portions and the two second concave portions are symmetrically provided at the two sides of the first extending plate, respectively.

In one embodiment, the first extending plate is located at a middle position of the front edge of the top wall.

In one embodiment, the first metal casing has two side extending walls respectively connected to two sides of the top wall, the two side extending walls are respectively located at two outer sides of the metal inner housing, and two grounding portions are respectively formed by extending downward from the two side extending walls, and configured to be electrically connected to a circuit board.

In one embodiment, the first metal casing has two side extending walls respectively connected to two sides of the top wall, the two side extending walls are respectively located at two outer sides of the metal inner shell, and two supporting legs are respectively formed by extending downward from the two side extending walls, and configured to downward abut a circuit board.

In one embodiment, the front end of the metal inner shell is provided with a guiding portion.

In one embodiment, the first body has a base portion and a tongue extending forward from the base portion, the metal inner housing wraps a periphery of the base portion and the tongue to form the insertion space between the metal inner shell and the tongue, the first extending plate is located in front of the tongue, the first terminals are provided in an upper and a lower row and respectively fixed on the base portion, and extend forward into the tongue, the first terminals in the upper row respectively have a plurality of conducting portions exposed from an upper surface of the tongue, the first terminals in the lower row respectively have a plurality of conducting portions exposed from a lower surface of the tongue, and a middle shielding sheet is provided between the first terminals in the upper row and the first terminals in the lower row.

In the electrical connector assembly according to certain embodiment of the present invention, the urging portion is located between the side wall and the first metal casing, and the side wall plays a role of stopping the urging portion, so that after being subject to a force, the urging portion does not excessively approach in a direction toward the side plate, and is not easily deformed; and after the urging portion is subject to a force, the side wall pressing the urging portion, so that elastic fatigue does not easily occur in the urging portion, and therefore grounding performance of the urging portion is stable, so as to improve product quality.

Further, the front edge of the top wall is provided with the first concave portion, located at a side of the first extending plate; and the front edge of the top wall is continuously provided with the protruding portion and the second concave portion from the first concave portion along a direction away from the first extending plate. Because the front end of the metal inner shell exceeds forward beyond the first metal casing, the first extending plate, the first concave portion, the protruding portion and the second concave portion do not easily scratch a user or a docking connector.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic three-dimensional exploded view of an electrical connector assembly according to one embodiment of the present invention.

FIG. 2 is a schematic three-dimensional view of the electrical connector assembly according to one embodiment of the present invention.

FIG. 3 is a partial sectional view of the three-dimensional view of the electrical connector assembly according to one embodiment of the present invention.

FIG. 4 is a sectional plane view of a front view of the electrical connector assembly according to one embodiment of the present invention.

FIG. 5 is a sectional plane view of a right view of the electrical connector assembly according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

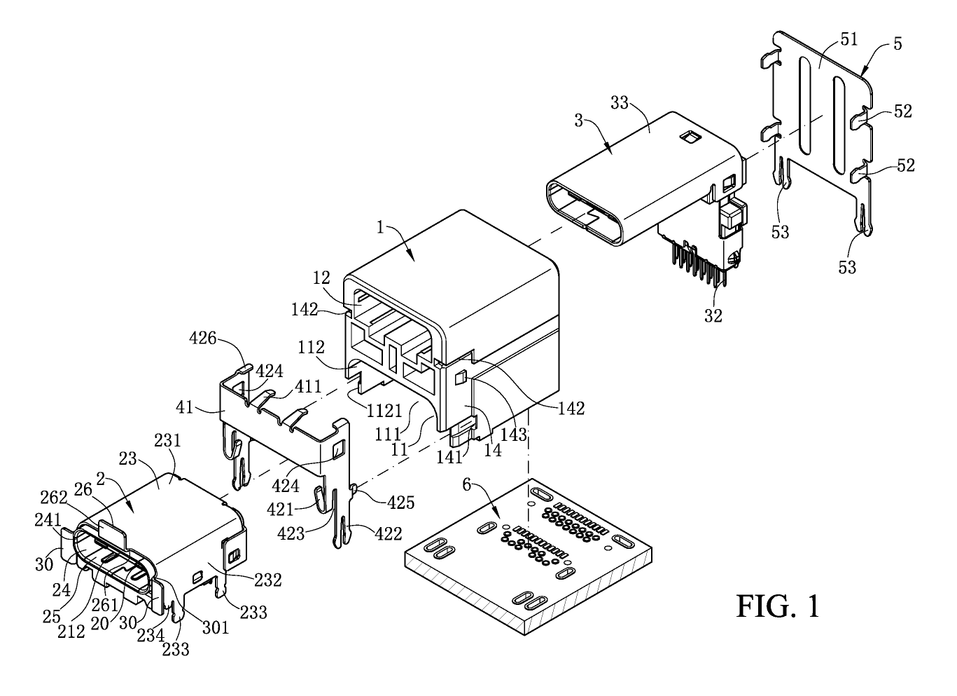

The description will be made as to the embodiments of the present invention in conjunction with the accompanying drawings in FIGS. 1-5. In accordance with the purposes of this invention, as embodied and broadly described herein, this invention, in one aspect, relates to an electrical connector assembly.

In certain embodiments, an electrical connector assembly of the present invention is installed on a circuit board 6 and may be provided for two mating connectors to be inserted therein and connected. The electrical connector assembly includes an insulating body 1, a first connector 2 and a second connector 3 that are disposed in the insulating body 1, a metal member 4 connected to the first connector 2 and the second connector 3, and a back shielding casing 5 shielding a back end of the insulating body 1.

The insulating body 1 is provided with a first accommodating cavity 11 and a second accommodating cavity 12. The first accommodating cavity 11 is located below the second accommodating cavity 12. The first accommodating cavity 11 accommodates the first connector 2. The first accommodating cavity 11 has a plugging slot for the mating connector to be inserted therein, and an opening 111, provided below the first accommodating cavity 11, for the first connector 2 to be soldered onto the circuit board 6 is. The first accommodating cavity 11 has two opposite side walls 112. A front edge of each of the side walls 112 is provided with a notch 1121 in a direction close to the circuit board 6. The second accommodating cavity 12 accommodates the second connector 3, and the second accommodating cavity 12 is through from front to rear. The back end of the insulating body 1 is provided with a depressed portion 13. A front end of each side surface of each of two opposite sides of the insulating body 1 is provided with a groove 14. Each of the grooves 14 has a first snap-fit slot 141, a second snap-fit slot 142 and a protruding portion 143. Multiple positioning posts (not shown) and multiple bosses 15 are disposed below the insulating body 1. The positioning posts are inserted into the circuit board 6 to fix the insulating body 1, and the bosses 15 press a surface of the circuit board 6.

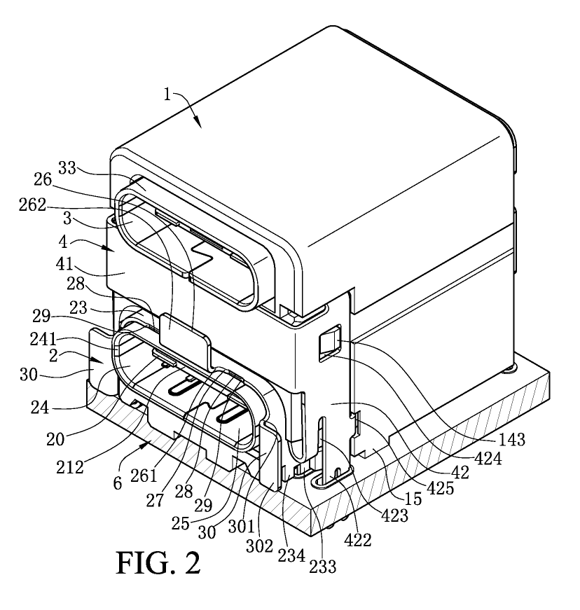

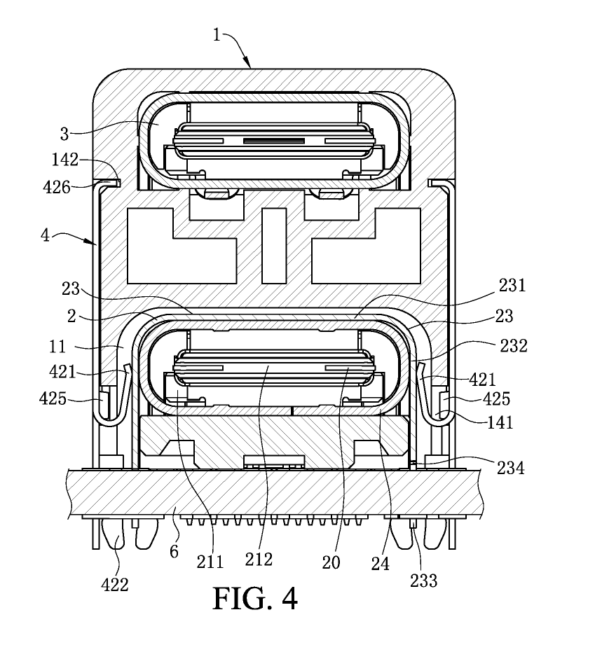

Referring to FIG. 1, FIG. 2 and FIG. 4, the first connector 2 includes a first body 21. The first body 21 has a base portion 211 and a tongue 212 that extends forward from the base portion 211. The multiple first terminals 22 are disposed in the first body 21 and are disposed in an upper row and a lower row, and are separately fixed at the base portion 211 and extend forward into the tongue 212. Multiple first terminals 22 in the upper row respectively have multiple conducting portions 221 exposed from an upper surface of the tongue 212, and multiple first terminals 22 in the lower row respectively have multiple conducting portions 221 that are exposed from a lower surface of the tongue 212. A middle shielding sheet 20 is disposed between the multiple first terminals 22 in the upper row and the multiple first terminals 22 in the lower row, and e is used to isolate signal interference between the multiple first terminals 22 in the upper row and the multiple first terminals 22 in the lower row, so as to improve high frequency performance. A metal inner shell 24 wraps periphery of the base portion 211 and the tongue 212 of the first body 21, and an insertion space 25 is formed between the metal inner shell 24 and the first body 21, and specifically, the insertion space 25 is formed between the metal inner shell 24 and the tongue 212, and the insertion space 25 is used for the butting connector to enter; and a first metal casing 23 wrapping the first body 21 and the first terminals 22. In this embodiment, the first connector 2 is of the USB C TYPE, and in others embodiments, the first connector 2 may be other types of connectors.

Referring to FIG. 1, FIG. 2 and FIG. 4, the first connector 2 includes a first body 21. The first body 21 has a base portion 211 and a tongue 212 that extends forward from the base portion 211. Multiple first terminals 22 are disposed in the first body 21. The first terminals 22 are disposed in an upper row and a lower row and respectively fixed at the base portion 211, and extend forward into the tongue 212. The first terminals 22 in the upper row respectively have a plurality of conducting portions 221 exposed from an upper surface of the tongue 212, and the first terminals 22 in the lower row respectively have a plurality of conducting portions 221 exposed from a lower surface of the tongue 212. A middle shielding sheet 20 is provided between the first terminals 22 in the upper row and the first terminals 22 in the lower row. The middle shielding sheet 20 is used to isolate signal interference between the first terminals 22 in the upper row and the first terminals 22 in the lower row, so as to improve high frequency performance. A metal inner shell 24 wraps the periphery of the base portion 211 and the tongue 212 of the first body 21, thus forming an insertion space 25 between the metal inner shell 24 and the first body 21. Specifically, the insertion space 25 is formed between the metal inner shell 24 and the tongue 212 for a docking connector to enter therein. A first metal casing 23 wraps the first body 21 and the first terminals 22. In this embodiment, the first connector 2 is of the USB C TYPE, and in others embodiments, the first connector 2 may be other types of connectors.

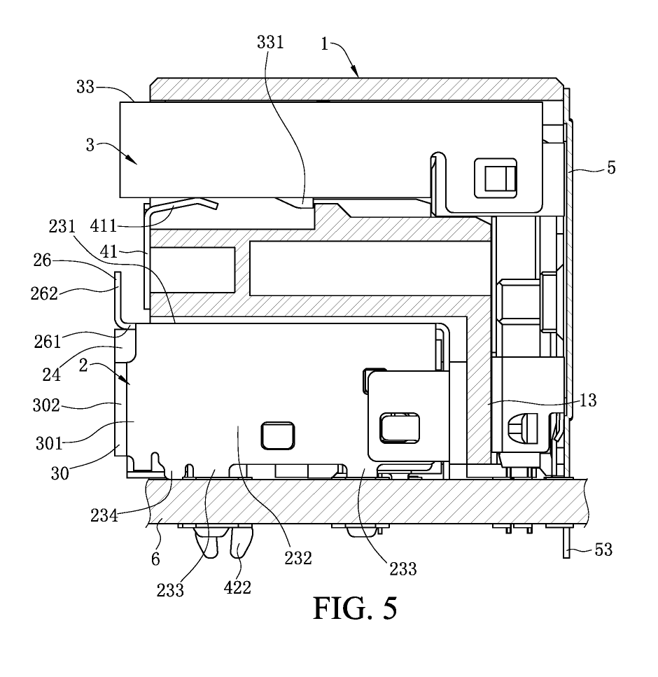

Referring to FIG. 1, FIG. 2 and FIG. 5, the first metal casing 23 is disposed outside of the metal inner shell 24, and a front end of the metal inner shell 24 exceeds beyond the first metal casing 23. The first metal casing 23 has a top wall 231, and the top wall 231 downward abuts the metal inner shell 24. The first metal casing 23 has two side extending walls 232 respectively connected to two sides of the top wall 231. The two side extending walls 232 are respectively located at two outer sides of the metal inner shell 24. A first extending plate 26 is formed by bending and extending upward from a front edge of the top wall 231. The first extending plate 26 is located at a middle position of the front edge of the top wall 231, and is located in front of the tongue 212. The front edge of the top wall 231 is provided with two first concave portions 27. The two first concave portions 27 are respectively located at two sides of the first extending piece 26. Further, the front edge of the top wall 231 is continuously provided with, from each of the first concave portions 27, a protruding portion 28 and a second concave portion 29 along a direction away from the first extending plate 26. In other words, there are two protruding portions 28 and two second concave portions 29. One of the two first concave portions 27, one of the two protruding portions 28, and one of the two second concave portions 29 are located at one side of the first extending plate 26, and the other one of the two first concave portions 27, the other one of the two protruding portions 28 and the other one of the two second concave portions 29 are located at the other side of the first extending plate 26. The two first concave portions 27, the two protruding portions 28 and the two second concave portions 29 located at the two sides of the first extending plate 26 are symmetrically provided, respectively.

Referring to FIG. 1, FIG. 2 and FIG. 5, the front edge of the top wall 231 is provided with the two first concave portions 27, and the two first concave portions 27 are respectively located at the two sides of the first extending plate 26. Further, the front edge of the top wall 231 is continuously provided with, from each of the first concave portions 27, a protruding portion 28 and a second concave portion 29 along a direction away from the first extending plate 26. Because the front end of the metal inner shell 24 exceeds beyond the first metal casing 23, the first extending plate 26, the first concave portion 27, the protruding portion 28 and the second concave portion 29 do not easily scratch a user or a docking connector. Further, a front edge of the metal inner shell 24 is provided with a guiding portion 241 for guiding the docking connector to enter the insertion space 25.

Referring to FIG. 1, FIG. 2 and FIG. 5, a width of each of the first concave portions 27 is greater than a width of each of the second concave portions 29, and a depth of each of the first concave portions 27 in a front-rear direction is greater than a depth of each of the second concave portions 29 in the front- rear direction, both of which facilitate formation of the first concave portions 27 and the first extending plate 26. The first extending plate 26 has a first connection portion 261 extending from the front edge of the top wall 231. The first connection portion 261 extends forward horizontally from the front edge of the top wall 231, and exceeds beyond the front edge of the protruding portion 28. A first extending portion 262 is formed by bending upward from the first connection portion 261. The first connection portion 261 is provided in such a way to allow the first extending portion 262 to be easily bent and formed. The first extending portion 262 and the top wall 231 are provided to be perpendicular to each other, and the first extending portion 262 and the front edge of the metal inner shell 24 are flush in a vertical direction. Therefore, it is convenient for the electrical connector assembly to be subsequently installed and fixed onto a chassis of a computer or another electronic device.

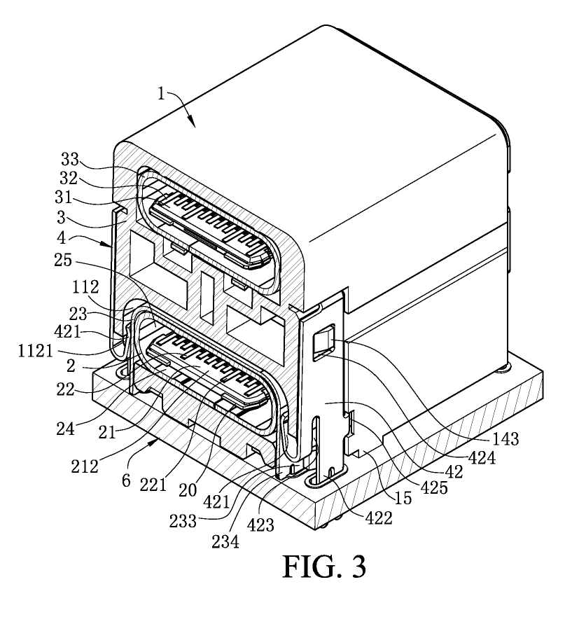

Referring to FIG. 1, FIG. 2 and FIG. 5, two second extending plates 30 are respectively formed by bending and extending from front edges of the two side extending walls 232 along directions away from the metal inner shell 24. Each of the second extending plates 30 has a second connection portion 301 extending from the front edge of the corresponding side extending wall 232, and a second extending portion 302 bending sideward from the second connection portion 301. The second connection portion 301 exceeds beyond the front edge of the protruding portion 28, to allow the second extending portion 302 to be easily bent and formed. A length of the first extending portion 262 is greater than a length of the second extending portion 302, and a width of the first extending portion 262 is greater than a width of the second extending portion 302. The second extending portion 302 and the top wall 231 are disposed to be perpendicular to each other, and the first extending portion 262 and the second extending portion 302 are flush in a vertical direction. Therefore, it is convenient for the electrical connector assembly to be subsequently installed and fixed onto a chassis of a computer or another electronic device. Referring to FIG. 3 and FIG. 5, two grounding portions 233 are respectively formed by extending downward from the two side extending walls 232. The grounding portions 233 is configured to be electrically connected to a circuit board 6, allowing the electrical connector assembly to be grounded, so as to improve high frequency performance. Two supporting legs 234 are respectively formed by extending downward from the two side extending walls 232. The supporting legs 234 are configured to downward abut the circuit board 6, and the supporting legs 234 are respectively disposed close to the grounding portions 233. Accordingly, the electrical connector assembly may be stably provided onto the circuit board 6 without being skew, and the supporting legs 234 may assist the grounding portions 233 to be inserted into the circuit board 6.

The second connector 3 includes a second body 31, multiple second terminals 32 disposed in the second body 31, and a second metal casing 33 wrapping the second body 31 and the second terminals 32. A tail portion of each of the second terminals 32 is disposed in the depressed portion 13 to position the second terminals 32. Two bumps 331 are disposed below the second metal casing 33. The bumps 331 and the bottom wall of the second accommodating cavity 12 are locked to fix the second metal casing 33, so as to prevent the second metal casing 33 from being unplugged or loosed by an exterior force. In this embodiment, the second connector 3 is of the USB C TYPE, and in others embodiments, the second connector 3 may be other types of connectors.

The metal member 4 is disposed at the outer side of the insulating body 1 and connects and conducts the first metal casing 23 and the second metal casing 33. The metal member 4 has a front plate 41 and side plates 42 respectively connected to two sides of the front plate. The front plate 41 is disposed at a front end of the insulating body 1, and the side plates 42 are disposed in the grooves 14 on the side surfaces of the two opposite sides of the insulating body 1. The front plate 41 is disposed between the first metal casing 23 and the second metal casing 33, and both the first metal casing 23 and the second metal casing 33 protrude forward from the front plate 41. A contact portion 411 extends from an upper side edge of the front plate 41 into the second accommodating cavity 12, the contact portion 411 is in contact with the second metal casing 33, and the contact portion 411 is located below the second metal casing 33.

An urging portion 421 extends downward from each of the side plates 42 and bypasses the corresponding notch 1121 or passes through the corresponding side wall 112 and is bent upward and extends into the first accommodating cavity 11, and the urging portion 421 is reversely bent and extends. The urging portions 421 draw close to each other and urge respectively two opposite sides of the first metal casing 23, so that contact between the urging portions 421 and the first metal casing 23 is more stable. Moreover, each of the urging portions 421 is located between the corresponding side wall 112 and the first metal casing 23, and the side corresponding wall 112 plays a role of limiting the urging portion 421, so that after being subject to a force, the urging portion 421 does not excessively approach in a direction toward the corresponding side plate 42, and is not easily deformed. After the urging portion 421 is subject to a force, the corresponding side wall 112 urges the urging portion 421, so that elastic fatigue does not easily occur in the urging portion 421. A grounding pin 422 extends downward from each of the side plates 42, and the grounding pins 422 are soldered onto the circuit board 6. In this embodiment, each of the grounding pins 422 is a harpoon pin, which helps the metal member 4 be locked onto the circuit board 6, and helps the metal member 4 be soldered and fixed. In other embodiments, the grounding pins 422 may be of a straight plate type. A gap 423 exists between each of the grounding pin 422 and the corresponding urging portion 421. Each of the gaps 423 enables the corresponding grounding pin 422 to be separated from the corresponding urging portion 421, and when the grounding pin 422 or the urging portion 421 is subject to a force, mutual affect between the grounding pin 422 and the urging portion 421 is reduced, so that performance of the metal member 4 is better.

A through-hole 424 is provided on each of the side plate 42, and the through-holes 424 are snap-fit respectively onto the protruding portions 143, so as to prevent the metal member 4 from being loosed and disengaged forward. A first buckling portion 425 and a second buckling portion 426 are disposed on each of the side plates 42, and the first buckling portions 425 and the second buckling portions 426 are correspondingly locked with the first snap-fit slots 141 and the second snap-fit slots 142. Each of the first buckling portion 425 is connected to the corresponding grounding pin 422, and the first buckling portion 425 and the corresponding urging portion 421 are located at a same height. When the urging portion 421 is subject to a force, the corresponding first buckling portion 425 firmly buckles the corresponding first snap-fit slot 141 to prevent the side plate 42 from expanding outward to loosen the metal member 4. When the urging portion 421 is subject to a force, the corresponding first buckling portion 425 firmly buckles the corresponding first snap-fit slot 141 to prevent the grounding pin 422 from expanding outward to disable under-plate soldering or prevent the grounding pin 422 from breaking or damage due to expanding outward caused by excessive violent force, thereby ensuring quality of the metal member 4. The second buckling portion 426 is disposed at an upper side edge of the side plate 42, so that the metal member 4 does not turn over due to force subjected to the urging portion 421, so as to improve the quality of the metal member 4 and ensure grounding performance thereof.

The back shielding casing 5 is disposed at a back end of the insulating body 1. The back shielding casing 5 has a main body portion 51, multiple buckling portions 52 located at two sides of the main body portion 51, and multiple soldering pins 53 located below the main body portion 51. The main body portion 51 shields tail portions of the second terminals 32. The buckling portions 52 are snap-fit onto the insulating body 1 to fix the back shielding casing 5. The soldering pins 53 are soldered to the circuit board 6 so that the back shielding casing 5 is grounded.

To sum up, certain embodiments of the electrical connector of the present invention, among other things, has the following beneficial advantages.

(1) The urging portions 421 draw close to each other and urge two opposite sides of the first metal casing 23, so that contact between the urging portions 421 and the first metal casing 23 is more stable.

(2) Each of the urging portions 421 is located between the corresponding side wall 112 and the first metal casing 23, and the side wall 112 plays a role of limiting the urging portion 421, so that after being subject to a force, the urging portion 421 does not excessively approach in a direction toward the side plate 42, and is not easily deformed. After the urging portion 421 is subject to a force, the corresponding side wall 112 urges the urging portion 421, so that elastic fatigue does not easily occur in the urging portion 421. Therefore, grounding/shielding performance of the urging portions 421 is stable.

(3) A gap 423 exist between each of the grounding pins 422 and the corresponding urging portion 421. The gap 423 enables the grounding pin 422 to be separated from the corresponding urging portion 421, and when the grounding pin 422 or the urging portion 421 is subject to a force, mutual affect between the grounding pin 422 and the corresponding urging portion 421 is reduced, so that performance of the metal member 4 is better.

(4) Each of the first buckling portions 425 is connected to the corresponding grounding pin 422, and the first buckling portion 425 and the corresponding urging portion 421 are located at a same height. When the corresponding urging portion 421 is subject to a force, the first buckling portion 425 firmly buckles the corresponding first snap-fit slot 141 to prevent the side plate 42 from expanding outward to loosen the metal member 4. When the corresponding urging portion 421 is subject to a force, the first buckling portion 425 firmly buckles the corresponding first snap-fit slot 141 to prevent the grounding pin 422 from expanding outward to disable under-plate soldering or prevent the grounding pin 422 from being from breaking or damage due to expanding outward caused by excessive violent force, thereby ensuring quality of the metal member 4.

(5) The second buckling portions 426 are disposed at an upper side edge of the side plates 42, so that the metal member 4 does not turn over due to force subjected to the urging portions 421, so as to improve the quality of the metal member 4 and ensure grounding performance thereof.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector assembly, comprising:
a first body;
a plurality of first terminals disposed in the first body;
a metal inner shell wrapping a periphery of the first body to form an insertion space between the metal inner shell and the first body; and
a first metal casing disposed outside of the metal inner shell,
wherein the metal inner shell has a front end exceeding beyond the first metal casing, the first metal casing comprises a top wall, the top wall has a front edge bending and extending upward to form a first extending plate, and wherein the front edge of the top wall is provided with a first concave portion located at a side of the first extending plate, and is further continuously provided with a protruding portion and a second concave portion from the first concave portion along a direction away from the first extending plate.

2. The electrical connector assembly according to claim 1, wherein the first extending plate has a first connection portion extending from the front edge of the top wall, and a first extending portion bending upward from the first connection portion, wherein the first connection portion exceeds beyond a front edge of the protruding portion.

3. The electrical connector assembly according to claim 2, wherein the first extending portion and the top wall are provided to be perpendicular to each other.

4. The electrical connector assembly according to claim 2, wherein the first extending portion and a front edge of the metal inner shell are flush in a vertical direction.

5. The electrical connector assembly according to claim 2, wherein the first connection portion extends horizontally forward from the front edge of the top wall.

6. The electrical connector assembly according to claim 2, wherein the first metal casing has two side extending walls respectively connected to two sides of the top wall, the two side extending walls are respectively located at two outer sides of the metal inner shell, and two second extending plates are respectively formed by bending and extending from front edges of the two side extending walls along directions away from the metal inner shell.

7. The electrical connector assembly according to claim 6, wherein each of the second extending plates has a second connection portion extending from the front edge of the corresponding side extending wall, and a second extending portion bending sideward from the second connection portion, wherein the second connection portion exceeds beyond the front edge of the protruding portion.

8. The electrical connector assembly according to claim 7, wherein a length of the first extending portion is greater than a length of the second extending portion.

9. The electrical connector assembly according to claim 7, wherein a width of the first extending portion is greater than a width of the second extending portion.

10. The electrical connector assembly according to claim 7, wherein the second extending portion and the top wall are provided to be perpendicular to each other, and the first extending portion and the second extending portion are flush in a vertical direction.

11. The electrical connector assembly according to claim 1, wherein a width of the first concave portion is greater than a width of the second concave portion.

12. The electrical connector assembly according to claim 1, wherein a depth of the first concave portion in a front-rear direction is greater than a depth of the second concave portion in the front-rear direction.

13. The electrical connector assembly according to claim 1, wherein the front edge of the top wall is provided with two first concave portions, two protruding portions and two second concave portions respectively located at two sides of the first extending plate.

14. The electrical connector assembly according to claim 13, wherein the two first concave portions, the two convex portions and the two second concave portions are symmetrically provided at the two sides of the first extending plate, respectively.

15. The electrical connector assembly according to claim 1, wherein the first extending plate is located at a middle position of the front edge of the top wall.

16. The electrical connector assembly according to claim 1, wherein the first metal casing has two side extending walls respectively connected to two sides of the top wall, the two side extending walls are respectively located at two outer sides of the metal inner housing, and two grounding portions are respectively formed by extending downward from the two side extending walls, and configured to be electrically connected to a circuit board.

17. The electrical connector assembly according to claim 1, wherein the first metal casing has two side extending walls respectively connected to two sides of the top wall, the two side extending walls are respectively located at two outer sides of the metal inner shell, and two supporting legs are respectively formed by extending downward from the two side extending walls, and configured to downward abut a circuit board.

18. The electrical connector assembly according to claim 1, wherein the front end of the metal inner shell is provided with a guiding portion.

19. The electrical connector assembly according to claim 1, wherein:
the first body has a base portion and a tongue extending forward from the base portion,
the metal inner housing wraps a periphery of the base portion and the tongue to form the insertion space between the metal inner shell and the tongue,
the first extending plate is located in front of the tongue,
the first terminals are provided in an upper and a lower row and respectively fixed on the base portion, and extend forward into the tongue,
the first terminals in the upper row respectively have a plurality of conducting portions exposed from an upper surface of the tongue,
the first terminals in the lower row respectively have a plurality of conducting portions exposed from a lower surface of the tongue, and
a middle shielding sheet is provided between the first terminals in the upper row and the first terminals in the lower row.
